(19) United States
(12) Patent Application Publication
(10) Pub. No.: US 2025/0052618 A1
(43) Pub. Date: Feb. 13, 2025

(54) Method for Spectral Colour Density Measurement in Colour Printing

(71) Applicant: Improve Process Analytics and Control GmbH, Villach (AT)

(72) Inventor: Christian Sallinger, Villach (AT)

(21) Appl. No.: 18/717,576

(22) PCT Filed: Dec. 8, 2022
(86) PCT No.: PCT/EP2022/084983

§ 371 Date: Jun. 7, 2024

(30) Foreign Application Priority Data
Dec. 9, 2021 (EP) 21213370.6

(51) Int. Cl. G01J 3/50; B41J 2/21; B41J 29/00

(52) U.S. Cl. CPC G01J 3/50; B41J 2/2107; B41J 29/00

(57) ABSTRACT

A method for spectrally measuring colour density in colour printing, in which a spectrally resolved reference reflectance is measured for an unprinted substrate with a spatially resolved spectral measuring system at a plurality of measuring points. At least one colour measuring field, preferably a plurality of colour measuring fields, is printed with a printing ink using a colour printer. The spectrally resolved reflectance for at least one colour measuring field is measured with the spatially resolved spectral measuring system at a plurality of measuring points and in which a colour density for the printing ink is calculated for each measuring point from the spectral distribution of the measured reflectance. The measured reference reflectance and a spectral weighting function representing the printing ink. The invention solves the technical problem of improving spectral colour density measurement in colour printing.

### CROSS-REFERENCE TO RELATED APPLICATIONS

This application is the United States national phase of International Patent Application No. PCT/EP2022/084983 filed Dec. 8, 2022, and claims priority to European Patent Application No. 21213370.6 filed Dec. 9, 2021, the disclosures of which are hereby incorporated by reference in their entireties.

### BACKGROUND OF THE INVENTION

### Field of the Invention

The invention relates to a method for spectral colour density measurement in colour printing.

This method relates to the field of densitometry in general and spectral densitometry in particular.

Densitometry is a method for controlling the printing process with regard to solid tone density and tonal values. It works reliably for black and white prints and for prints with the process colours cyan (blue), magenta, yellow (yellow) and key (black).

In incident light densitometry, the ink to be measured is illuminated by a light source. The light beam penetrates the translucent (transparent) ink layer and is attenuated in the process. The remaining light is scattered by the paper substrate. Some of this scattered light passes through the colour layer again and is further attenuated. The remainder finally reaches the measuring device, which converts the light into electrical energy. The result of incident light densitometry is given in density units.

The colour density of a printing ink is primarily dependent on the type of pigment, its concentration and the thickness of the ink layer. For a given printing ink, the colour density is a measure of the layer thickness.

In classic densitometry, colour filters are used in the beam path that are matched to the absorption behaviour of the colours cyan, magenta and yellow.

If printed surfaces are to be measured directly after the printing process, the ink is still wet and has a glossy surface. As it dries, the ink penetrates the paper and loses its gloss. This not only changes the colour tone of the ink, but also the ink density value. If the still wet printing medium is to be compared densitometrically with the generally dry target values, this is only possible to a limited extent.

As a remedy, two crossed linear polarisation filters are placed in the beam path. Polarisation filters only allow one direction of oscillation through from the light waves oscillating in all directions. The light rays aligned by the first polarisation filter are partially reflected by the coloured surface. Their direction of oscillation does not change. The second polarisation filter is arranged at a 90° angle to the first so that these reflected light waves are not transmitted.

However, if light rays penetrate the ink layer and are reflected back from there or only from the substrate, they lose their uniform direction of oscillation (polarisation). They are therefore partially transmitted by the second polarisation filter and can be measured. By blocking the gloss components of the light reflected by the wet ink, the densitometric measured values for wet and dry inks are therefore approximately the same.

Densitometers display the colour density D as the measurement result. It is the logarithmic ratio of the light reflection by a reference white and the light reflection of the colour layer. The colour density value is calculated using the formula D=log 1/β. The reflectance β represents the ratio LeP/LeW. LeP is the reflectance of the measured ink and LeW is the reflectance of the reference white. D can therefore also be represented as log LeW/LeP.

The reflectance β therefore indicates the ratio between the light reflections of a sample to be measured (printing ink) and a white (reference value). The reflectance β is often also referred to as the reflectance factor R_{λ}.

With the classic densitometer, the individual printing colours cyan, magenta and yellow are measured with the help of colour filters, so that a separate measuring process is necessary for each of the colours.

Spectral densitometry uses the measuring principle of recording spectral reflectance, from which all other colourimetric and densitometric values can be calculated.

The sensor of the spectrodensitometer is sensitive to large parts, in particular the entire visible range of the electromagnetic spectrum, i.e. all wavelengths of visible light. The sensitivity range starts at around 380 nm in the violet and extends through the colour nuances blue-green, green and yellow to red at around 730 nm.

The spectral reflectance values are measured simultaneously for all wavelength sections (bands) using a polychromator or spectral measuring head. The bands each cover wavelength ranges with a specified width. For example, polychromators are known that can resolve bands with a width between 10 and 50 nm. The light is fanned out by a diffraction grating, a prism or many narrow band filters. In any case, the measured luminous flux is divided into its spectral components, the signal strengths of which are measured and output in their entirety as a spectral value curve.

In contrast to conventional densitometers, spectral measurement uses the spectral colour information to calculate the colour layers. In addition, the colour densities for cyan, magenta, yellow and other colours can be determined from the spectral measurement values without the need for separate measurements with different colour filters.

In spectral densitometers, photosensitive sensors scan the entire visible range of the electromagnetic spectrum to determine the spectral reflectance values when determining the densitometric values. Both physical filters can be swivelled into the beam path and virtual, i.e. mathematically simulated, filters can be set. In addition, the standard-compliant density measurement requires the above-mentioned use of a polarisation filter, which suppresses the gloss differences between wet and already dried ink layers. In this way, the measurements are made comparable regardless of the time proximity to the printing process.

### Description of Related Art

The use of mathematically simulated filters is defined in the standards ISO 13655 Chapter 5 and ISO 5.3 Chapter 4.5.2 together with Annex B. From the measured reflectance and by convolution with the filter function for various primary colours such as cyan, magenta and yellow, values of the colour densities for the tristimulus values X, Y and Z are obtained, preferably in the CIE standard system.

In practice, hand-held measuring devices for individual measurements, hand-held scanning devices for manual measurement of measuring fields arranged in a line and scanning measuring devices driven by an electric motor are used as scanning spectral densitometers. Inline measuring systems are also known, which are arranged in a printing system and measure printed measuring fields one after the other. What these devices have in common is that the reflectance spectrum is spectrally recorded at one location on the printed image to be measured using an optical system and a sensor arrangement. The dimensions of the detected, preferably round area are in the order of 1 to 10 mm.

The colour measurement fields printed on the print medium are usually rectangular or square. Colour gradients for one of the printer's primary colours are printed in gradations from 100% to 0% in steps of, for example, 10%, the colour densities of which are then spectrally determined using one of the measuring devices described. The area of each colour measuring field is not completely captured by the optics of the measuring device, as the area observed by the optics is usually round. This means that the corners of the measurement fields are not detected. In addition, only one value for the colour density is determined for the measured area.

Colour measurement systems (ACMS™—Advanced Colour Measurement System) and an inline colour measurement system (ICMS™—Inline Colour Measurement System) from the company ipac, which are used to assess the colour of multi-coloured surfaces, are also known from the state of the art. The system has a spectral scanner, possibly arranged inline, which can be used for different substrates, i.e. print media or materials (paper, film, wood, plastic, ceramic, mineral material) and different printing processes (digital printing, in particular inkjet printing or laser printing, as well as gravure printing, flexographic printing, offset printing or screen printing). The ICMS™ and the ACMS™ use spectral spatially resolved scanning technology to measure a printed image.

The spectral measurement system is, for example, a multispectral camera with a number of wavelength bands, preferably with 36 wavelength bands per recorded pixel, which generates one piece of colour information per wavelength band. This produces a colour spectrum from the wavelength bands for each recorded pixel. A common sensor technology consists of providing individual pixels on a CMOS sensor with different colour filters so that a plurality of spectral information from a captured image area can be recorded with one image capture.

The spectral measurement system can also be a hyperspectral camera in which the light is spectrally split per pixel using an optical device, for example a prism, and thus individual spectral ranges are measured separately. This increases the spectral resolution compared to a multispectral camera to, for example, up to 350 or more wavelength bands.

In contrast to a conventional RGB camera, not just one colour is obtained per pixel, but a spectral distribution with considerably more depth of information. Image information from different spectral images is then compared using software.

Furthermore, a resolution of the scanner of at least 32 dpi, preferably at least 72 dpi, particularly preferably at least 90 dpi can be achieved.

### SUMMARY OF THE INVENTION

The present invention is therefore based on the object of improving spectral colour density measurement in colour printing.

The above technical problem is solved according to the invention by the features as described herein.

The process for spectral colour density measurement in colour printing has the following steps:

Firstly, a spectrally resolved reference reflectance is measured for an unprinted substrate using a spatially resolved spectral measurement system, preferably at a large number of measurement points. This reflectance is required to normalise the reflectances to be measured later. The reference measurement can be carried out before the substrate is printed and, if necessary, continuously during the printing process. For this purpose, unprinted sections of the substrate must be left free at predetermined positions during the printing process. The substrate can be a print medium or material in the form of paper, film, wood, plastic, ceramic, mineral or other materials.

A colour printer is used to print at least one colour measuring field, preferably a plurality of colour measuring fields, with at least one printing ink.

A printing ink is generally understood to be a mixture of colourants that is transferred to a substrate such as paper or plastic using a printer. In digital colour printers in particular, three printing inks are used: cyan, magenta and yellow and possibly black (key). In addition or alternatively, further or other printing inks with different pigment compositions can also be used.

Various techniques can be used for colour printing, for example digital printing, in particular inkjet printing or laser printing, as well as gravure printing, flexographic printing, offset printing or screen printing. In the case of inkjet printers, the printing colours are in the form of inks, while laser printers use toner. For other colour printers, different ink formulations based on water, oils or solvents are used as printing inks.

One colour measuring field of a printing colour is sufficient to carry out the process, but so-called colour wedges are usually printed for each of the printing colours, which have a number of colour measuring fields graded in their colour density for each printing colour. Gradations in steps of 10%, 5% or 1% are common, whereby colour measuring patches with tonal values of 100% and 0% are usually also included. The colour patch with a tonal value of 0% can be used to measure the spectrally resolved reference reflectance of the unprinted substrate.

The spectrally resolved reflectance for at least one colour measurement field is then measured at a large number of measurement points using the spatially resolved spectral measurement system. In this way, spectrally resolved colour measurements are carried out distributed over at least a partial area of the colour measurement field, preferably over the entire colour measurement field.

The measuring system has either a line sensor or a two-dimensional sensor of a hyperspectral camera. In any case, the sensor has a large number of pixels for each of which a spectrum is recorded. This achieves sufficiently high resolutions to measure the various colour measuring fields at a number of measuring points. This achieves a spectral resolution of preferably 36 or up to 350 or more wavelength bands. A resolution in the range of 10 nm, in particular in the range of 1 to 30 nm, is then achieved per wavelength band. This covers the visible spectrum of light between 380 and 730 nm.

For each measuring point, a colour density for the printing ink is calculated from the spectral distribution of the measured reflectance, the measured reference reflectance and a spectral weight function representing the printing ink. This is preferably done in accordance with the standards ISO 13655 Chapter 5 and ISO 5.3 Chapter 4.5.2 together with Annex B.

For example, ISO 5.3 Annex B defines that, depending on the width of the spectral channels for a width or an interval of 1 nm, the calculation is carried out according to equation B.1 in Annex B.3 and for channel widths or intervals of 10 or 20 nm the calculation is carried out according to equation B.2. What the calculations have in common is that the spectral reflectance for the wavelength-dependent channels is multiplied by the weighting function, divided by a normalisation factor and added up over all wavelengths.

This results in a value for the colour density from each measured spectral reflectance for each measuring point within each colour measuring field.

In addition, the measuring system can be arranged as an inline measuring device in the area of the printer or used as an offline device for subsequent measurement of the printed surface.

In a preferred manner, the colour measurement system is aligned and moved relative to the at least one colour measurement field in such a way that the at least one colour measurement field is measured in a grid-like manner at a large number of measurement points with a resolution of at least 30 dpi, preferably at least 70 dpi, in particular at least 90 dpi. An upper limit is, for example, in the range of 250 dpi. In particular, the line sensor or the two-dimensional sensor is aligned perpendicular to the direction of movement relative to the printed substrate, so that the resulting measurement grid is aligned in the direction of movement. Traversing, with simultaneous 90° rotation of the colour measurement system, transverse to the actual direction of movement is equally possible.

Furthermore, in a further embodiment of the method, it is possible for at least 80%, preferably at least 90%, in particular at least 95% of the area of the at least one colour measurement field to be measured. As a result, the colour measurement field is measured almost completely, in particular completely, and the determined colour densities enable a more precise analysis of the colour density distribution, i.e. the print result over the area of the colour measurement field.

In particular, the colour densities are averaged for at least two measuring points, preferably a plurality of measuring points and in particular for all measuring points of each colour measuring field. The large number of measuring points thus allows an accurate and at the same time variable evaluation of the colour measuring field.

In a further preferred method, when using an inkjet printer, a group of ink nozzles (nozzles) of a print head is assigned to each measuring point of the raster-shaped spectral colour density measurement of the at least one colour measuring field. The group of colour nozzles has a maximum of 10 colour nozzles, preferably a maximum of 5 colour nozzles, in particular one colour nozzle. Depending on the areal resolution of the print and the spatial resolution of the measuring system, it is therefore possible to analyse up to a few colour nozzles or, in borderline cases, up to individual colour nozzles. A print head typically has a width of 40-50 mm and the colour printer then has a number of print heads that realise a total print width of approx. 1000 mm.

The process described above with its various configurations can be used for single-pass printing or multi-pass printing.

The procedure is carried out with a specified illumination of the surface to be printed or the printed surface. The choice of lighting follows the requirements of ISO standard 13655, in particular measurement condition M3. Preferably, the standardised lighting type D50 is used.

Polarisation filters can also be arranged in the beam path in order to be able to measure even wet print images.

### BRIEF DESCRIPTION OF THE DRAWINGS

In the following, the invention is explained with reference to the drawing by means of examples of embodiments. The drawing shows

FIG. 1 a first system for carrying out a process according to the invention,

FIG. 2 a second system for carrying out a process according to the invention,

FIG. 3 a third system for carrying out a process according to the invention,

FIG. 4 an example of a spectral measuring system for carrying out a method according to the invention,

FIGS. 5(a)-(b) examples of a printed substrate with a printed colour wedge with a plurality of colour measurement fields and a schematic representation of the coverage of the colour measurement fields by the spectral measurement according to the present invention (a) and according to the prior art (b),

FIG. 6 an example to illustrate the calculation of the spectral reflectance factor (R_{λ}) from the spectral reflectance of the colour measurement field using cyan as an example and the spectral reflectance of the unprinted substrate, and

FIG. 7 is an example to illustrate the calculation of the colour density D from the spectral reflectance factor (R_{λ}) and the weighting factor (W_{λ}).

### DESCRIPTION OF THE INVENTION

In the following description of the various embodiments according to the invention, components and elements with the same function and the same mode of operation are provided with the same reference signs, even if the components and elements may differ in their dimensions or shape in the various embodiments.

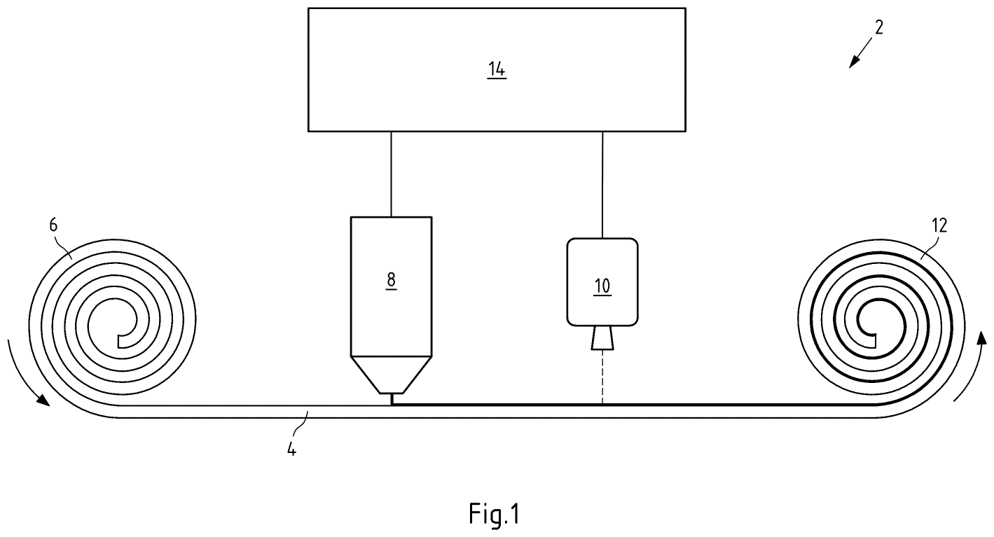

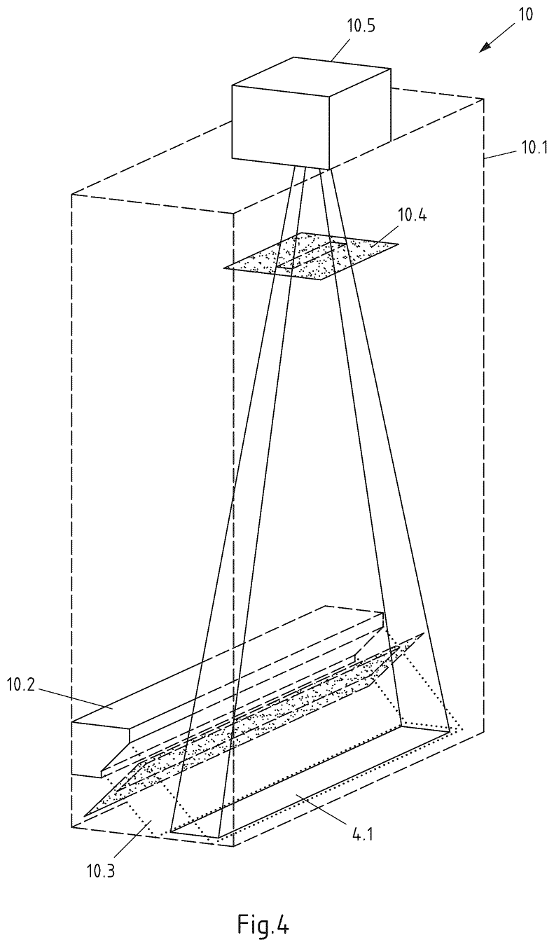

FIG. 1 schematically shows a first system 2 for carrying out the method for spectral colour density measurement in colour printing. First, the carrier material 4 is unrolled from a first roll 6, guided underneath the colour printer 8 and the spectral measuring system 10 and then rolled up again on a roll 12. In this respect, one can speak of a continuous carrier material 4 with which the continuous printing and colour density measurement is carried out. It goes without saying that the endless tape has a finite but long length. The spectral measuring system is shown in simplified form and is explained in more detail using FIG. 4 as an example.

In the present case, the colour printer 8 is designed as a digital inkjet printer with which the surface of the substrate is printed in the inline process shown. In this application, inkjet printers are preferred, but the invention is not limited to the use of inkjet printers.

The results of the spectral measurements by the spectral measurement system are transmitted to a control device 14, which analyses the recorded spectral data.

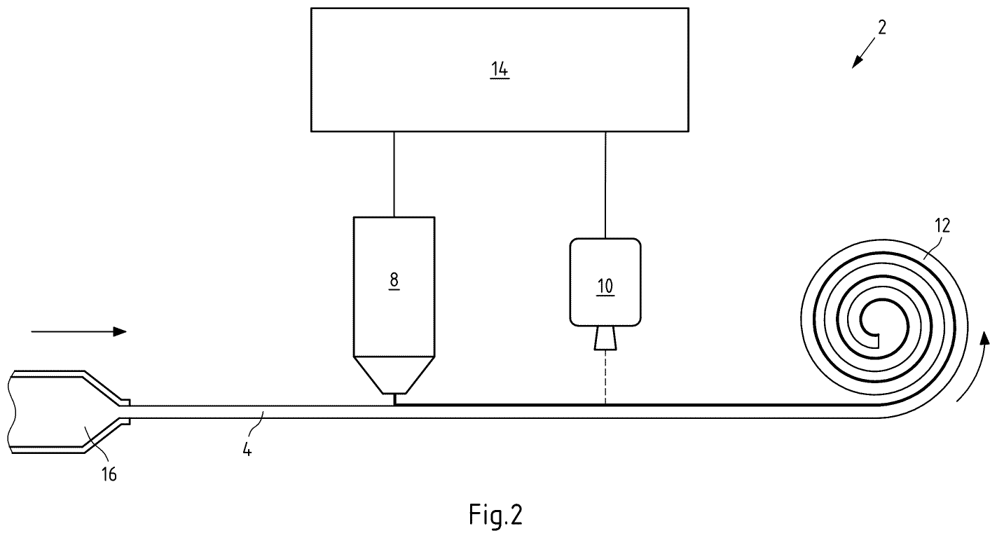

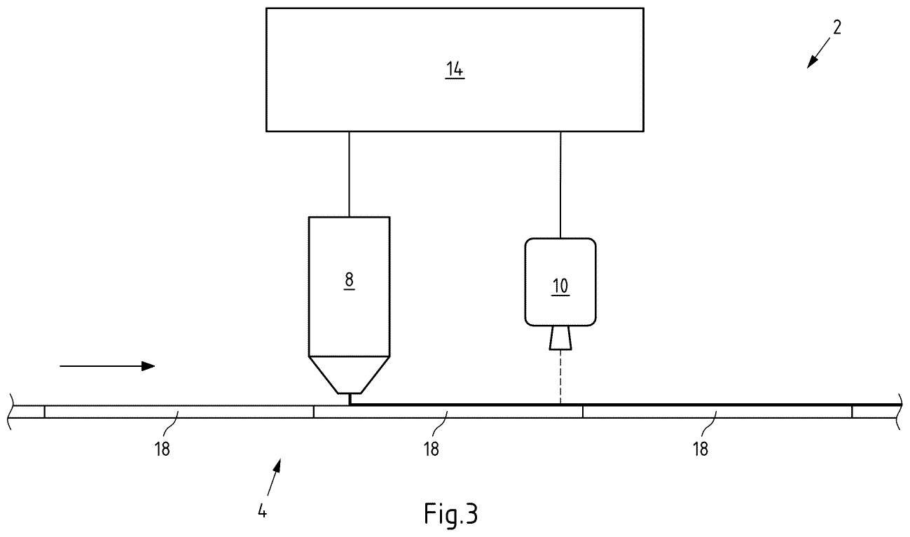

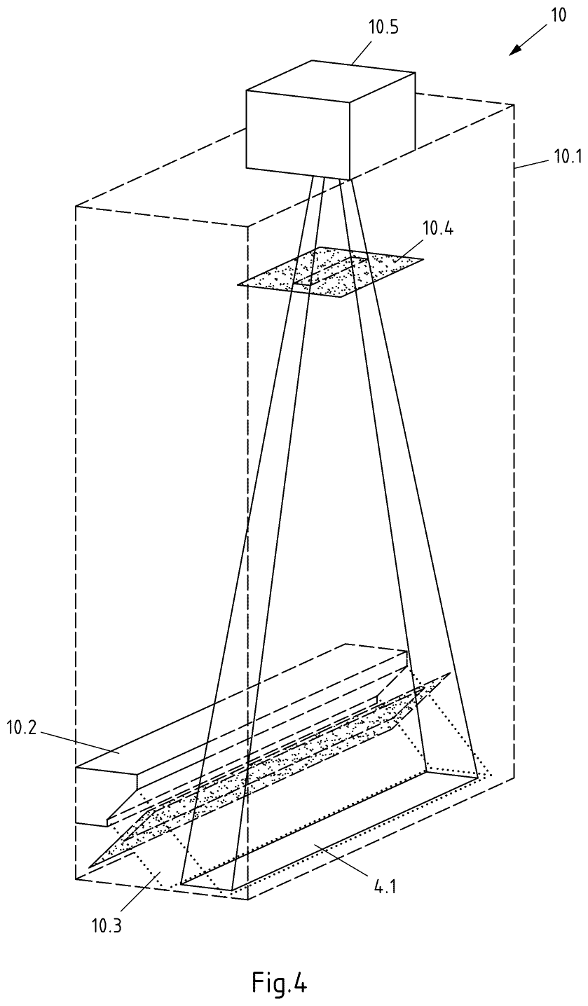

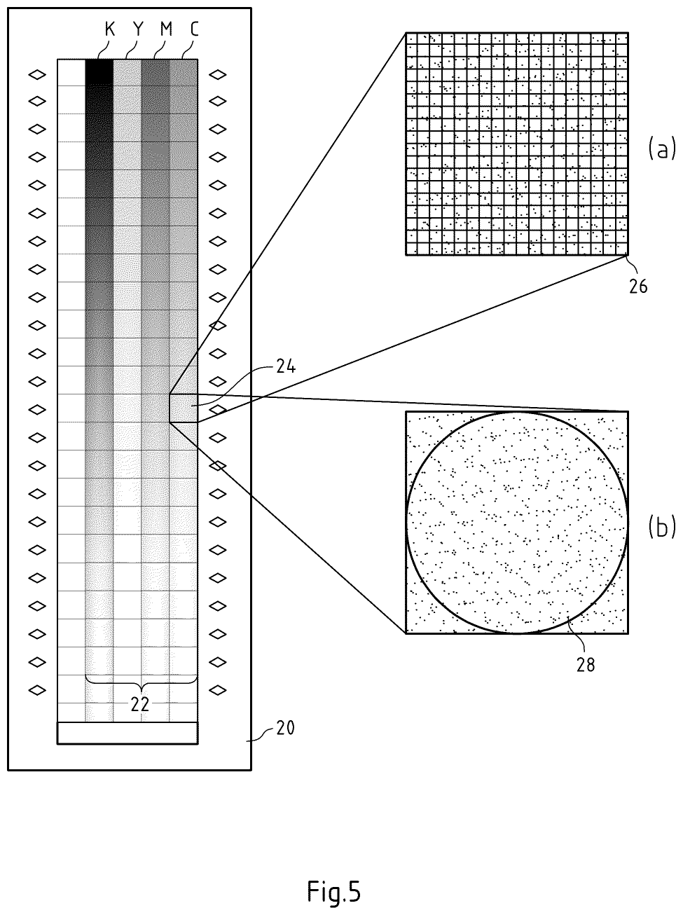

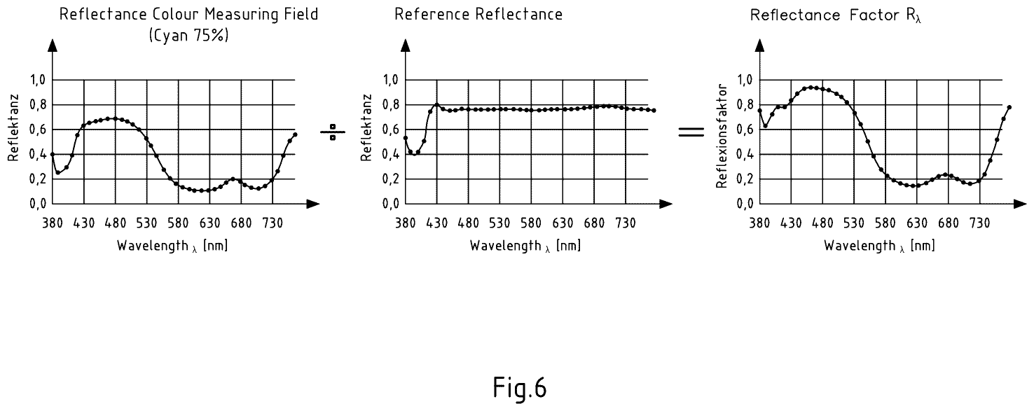

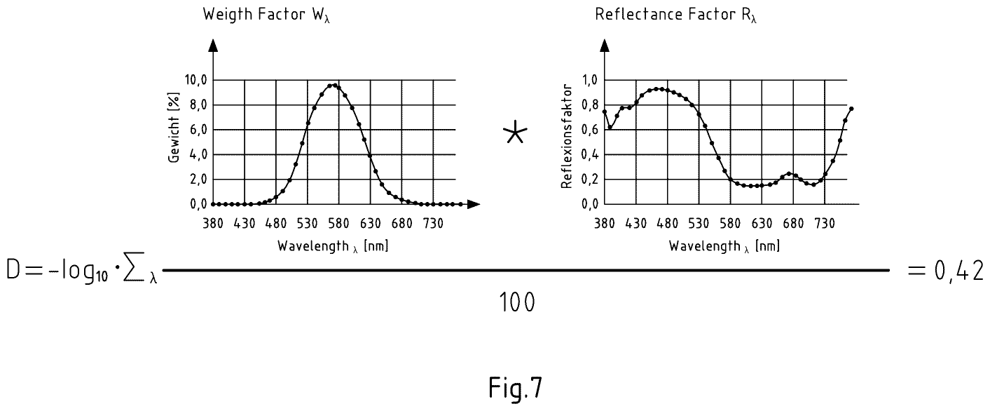

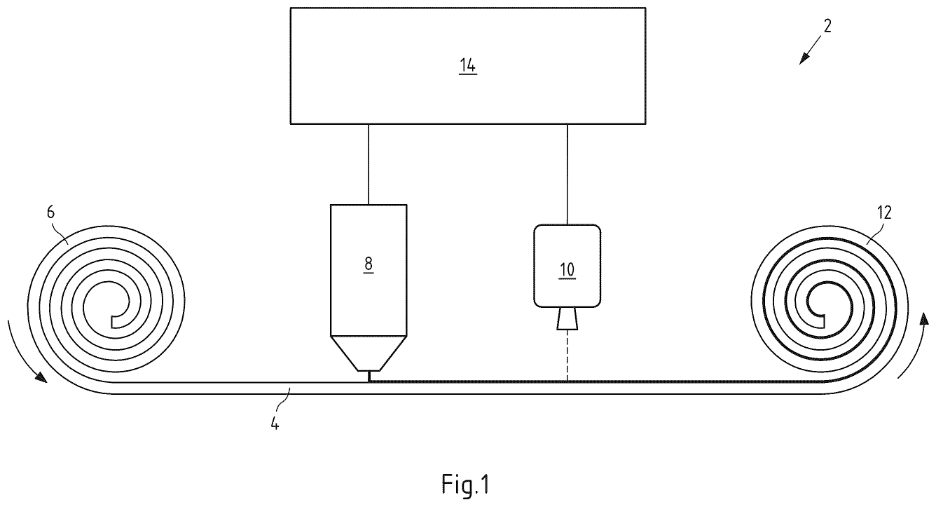

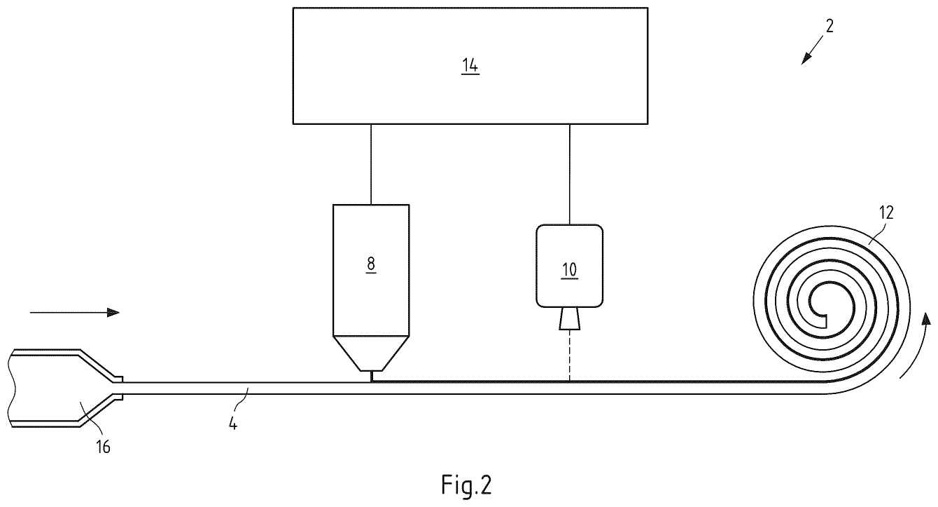

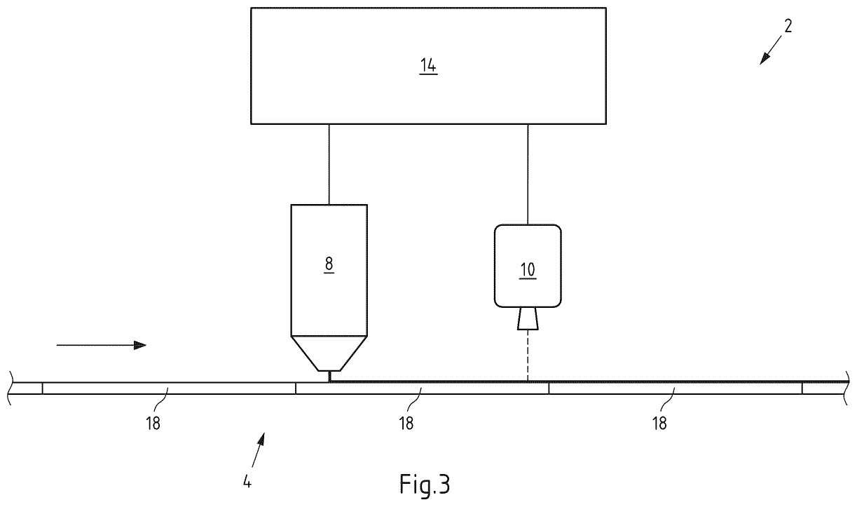

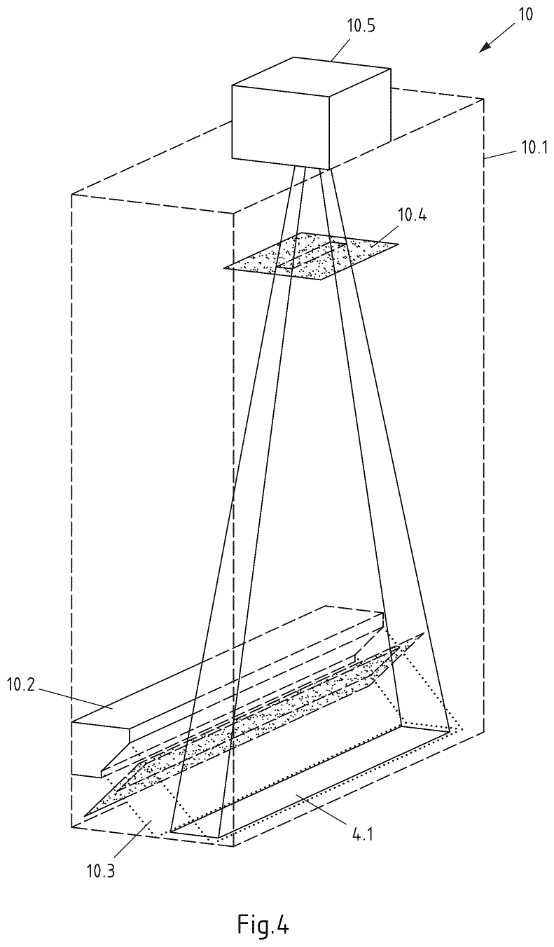

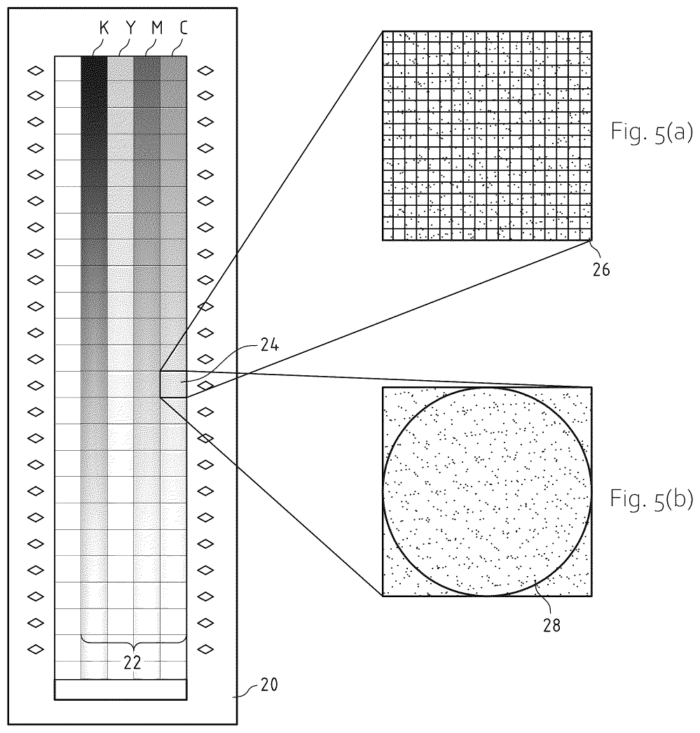

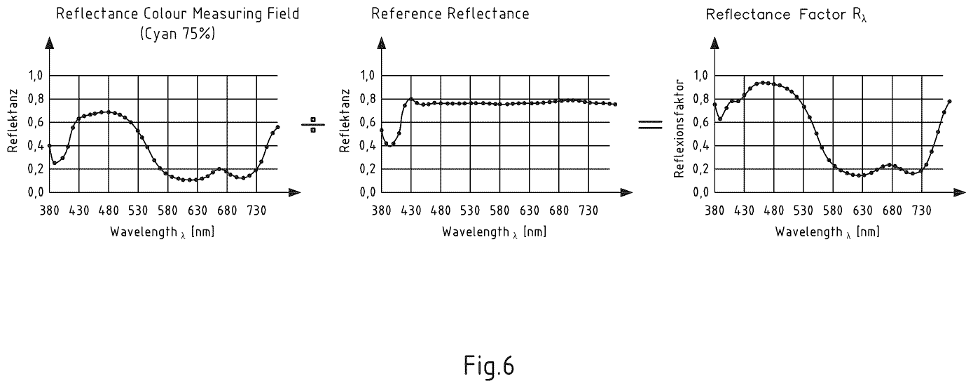

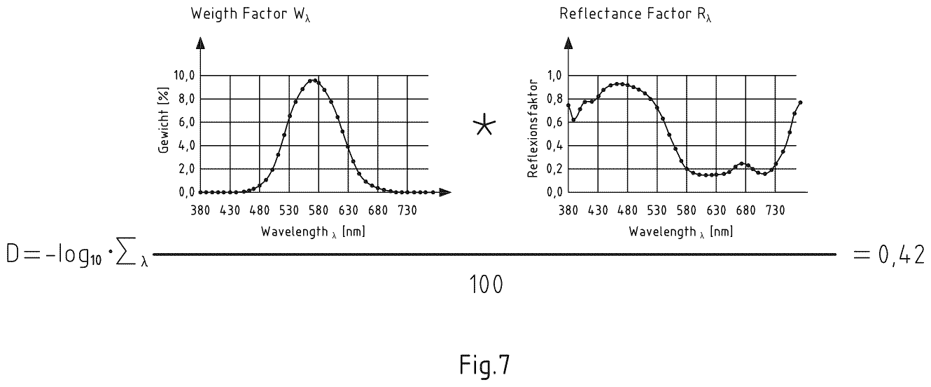

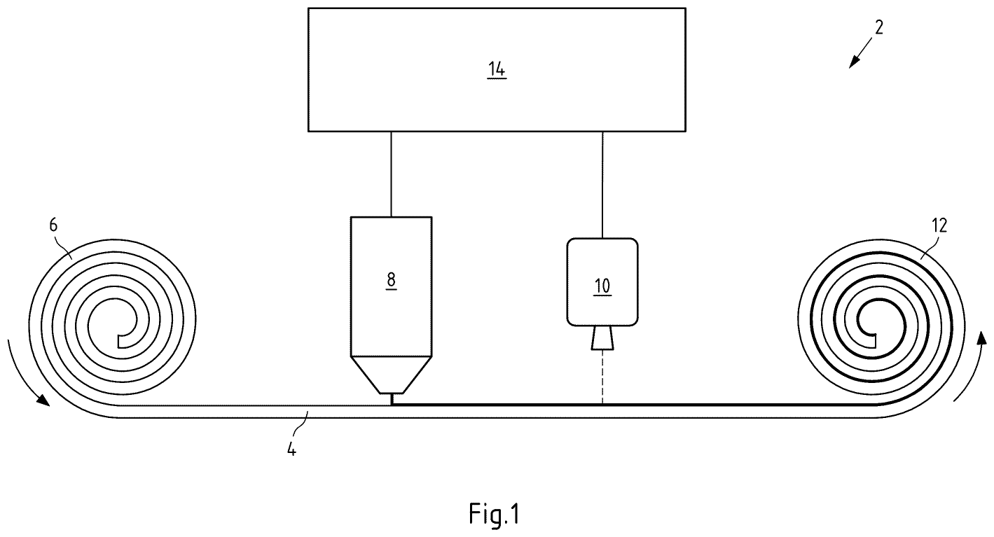

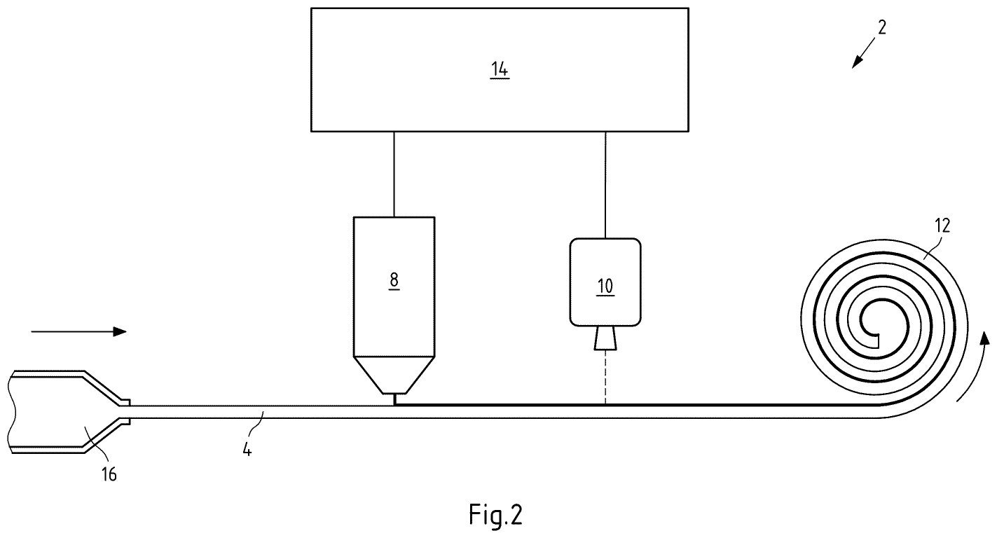

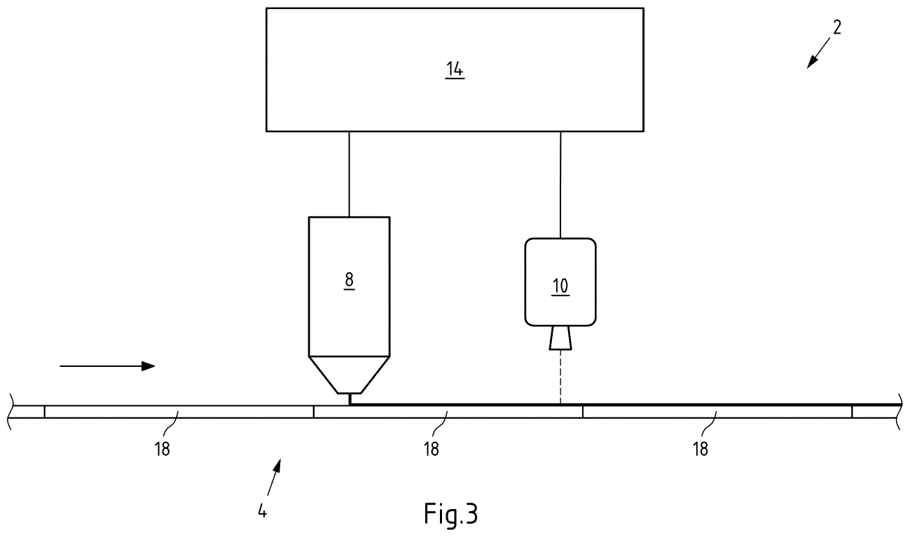

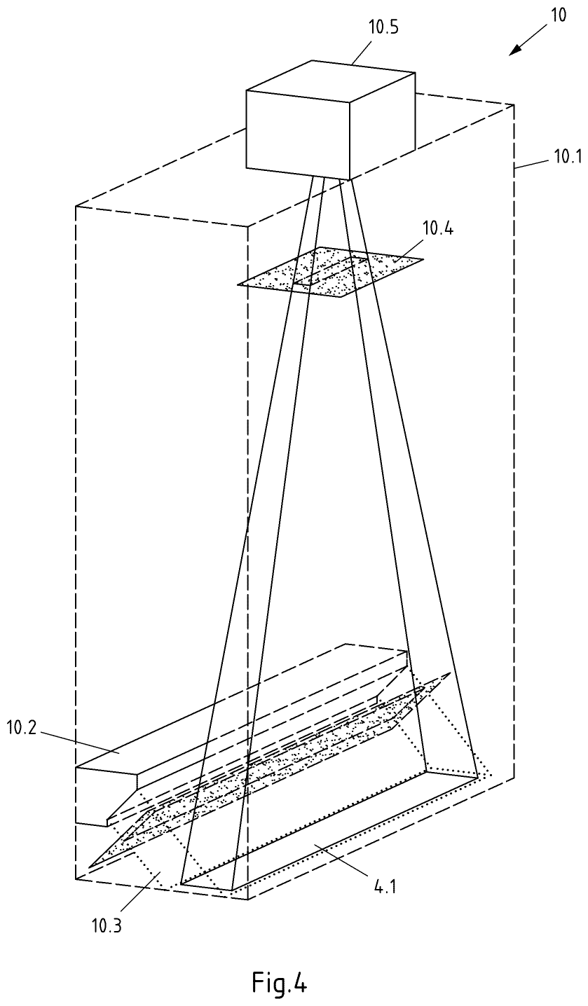

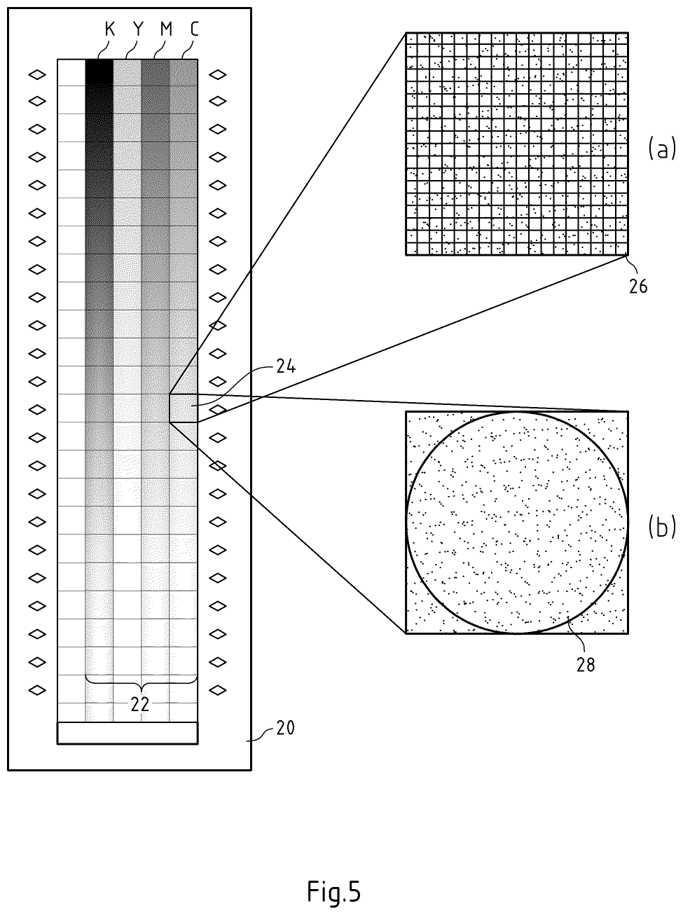

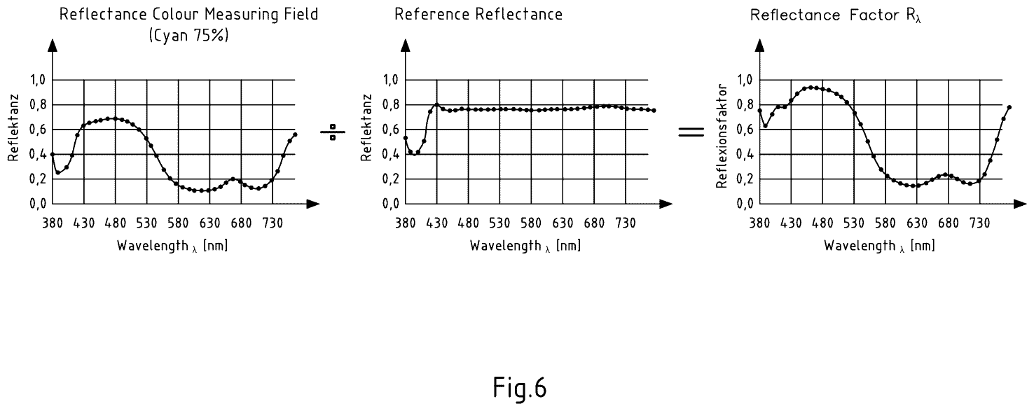

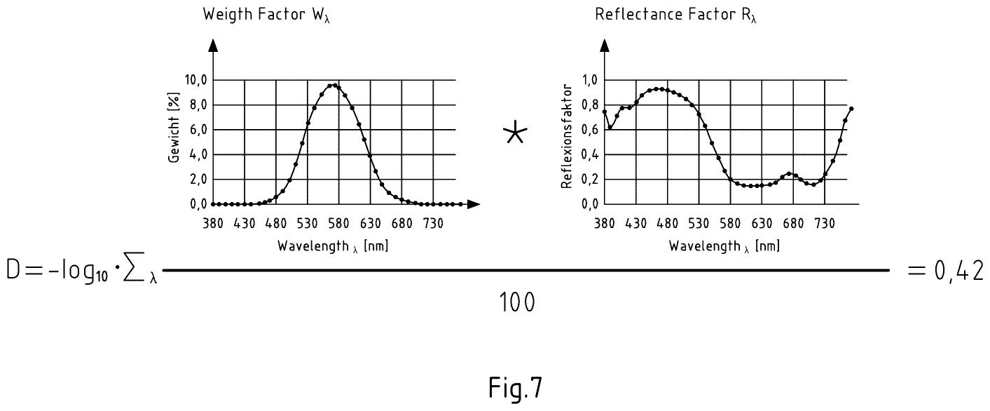

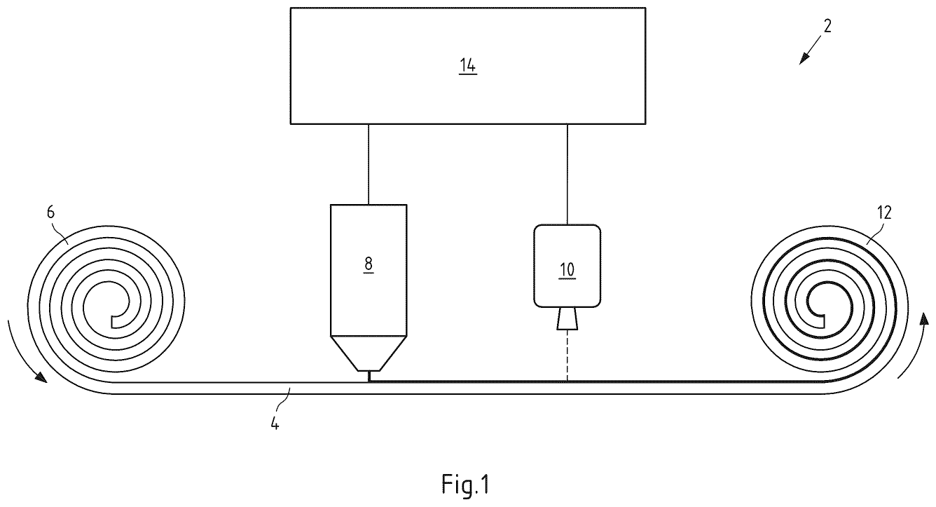

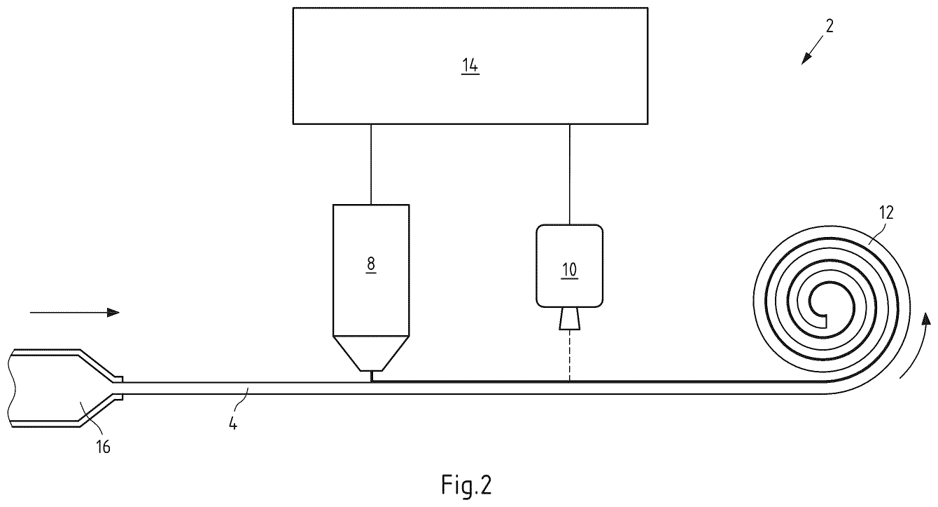

FIG. 2 schematically shows a second system 2 for carrying out the method for spectral colour density measurement in colour printing. In contrast to the system shown in FIG. 1, the carrier material 4 is not unwound from a roll, but is produced by an extrusion process. For this purpose, an extrusion tool 16 is shown schematically, from which a strand is extruded to produce, for example, an edge material for use in furniture panels. For the sake of simplicity, the necessary calendering and cooling stations are not shown here. Instead of the extrusion tool 16, a continuous casting device can also be used to produce a continuous strand of carrier material.

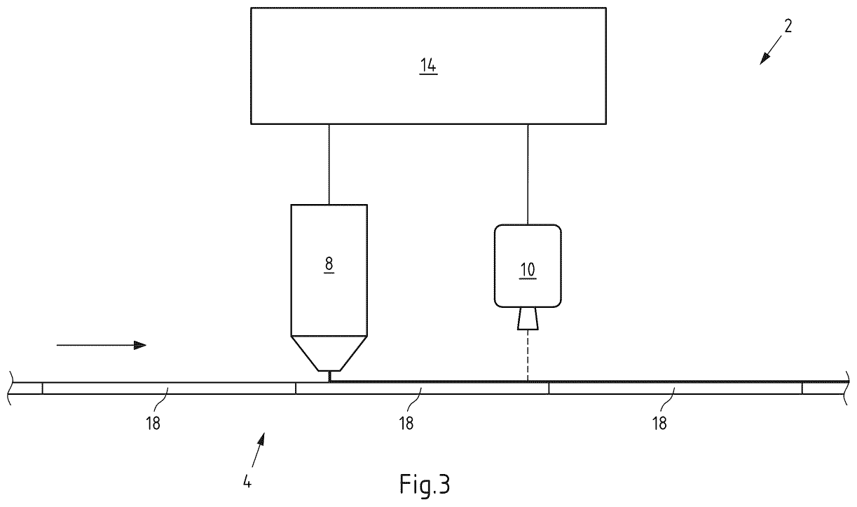

FIG. 3 schematically shows a third system 2 for carrying out the method for spectral colour density measurement in colour printing. In comparison to the systems shown in FIGS. 2 and 3, the carrier material 4 is not formed as a continuous material, but consists of a plurality of abutting elements 18, for example plates or sheets. The backing material 4 therefore consists of individual elements 18 that are present separately before and after printing. The continuous printing and measuring of colour charts then takes place on the carrier material 4 composed of individual elements 18.

FIG. 4 shows an embodiment example of a spectral measuring system 10 for carrying out a method according to the invention. The measuring system 10 initially has a housing 10.1 in which the components are arranged. An illumination device 10.2 is arranged in the housing 10.1, which illuminates a scanning area 4.1 on the surface of the carrier material 4. This generates light of a standardised illumination type, for example D50, with a predetermined spectral intensity distribution over the visible spectral range from 380 to 730 nm.

A first polarisation filter 10.3 is arranged in the beam path in front of the scanning area, which polarises the incoming light before it hits the scanning area 4.1. The light reflected from the scanning area 4.1 then travels in the direction of a second polarisation filter 10.4. The first polarisation filter 10.3 only allows one direction of oscillation through from the light waves oscillating in all directions. The light rays aligned by the first polarisation filter 10.3 are partially reflected by the colour surface in the scanning area 4.1, in particular if the surface is still wet due to a printing process that took place shortly beforehand, or at least has not yet dried out. In the case of specular reflection, the direction of oscillation of the light does not change. The second polarisation filter 10.4 is arranged rotated by 90° relative to the first polarisation filter so that the light waves reflected by the scanning area 4.1 are not transmitted.

The described polarisation filters can also be omitted for a spectral measurement of dried colour prints.

The measuring and evaluation device 10.5 is arranged in the beam path behind the second polarisation filter 10.4. This contains a multispectral or hyperspectral camera, with which a spectral intensity distribution is measured for each captured pixel of the scan area 4.1, preferably in 36 wavelength bands per captured pixel. This generates one piece of colour information per wavelength band, which together form a spectrum. This results in a colour spectrum of preferably 36 wavelength bands per recorded pixel. A common sensor technology consists of providing individual pixels on a CMOS sensor with different colour filters so that a plurality of spectral information from a captured image area can be recorded with one image capture.

The spectral measurement system can also have a hyperspectral camera, which has an increased spectral resolution of up to 350 or more wavelength bands per measurement point compared to a multispectral camera, for example.

The spectral information is then preferably analysed within the spectral measurement system using data processing.

The method according to the invention for spectral colour density measurement in colour printing can then be carried out with a system 2 with spectral measuring system 10 shown in FIGS. 1 to 4 as follows.

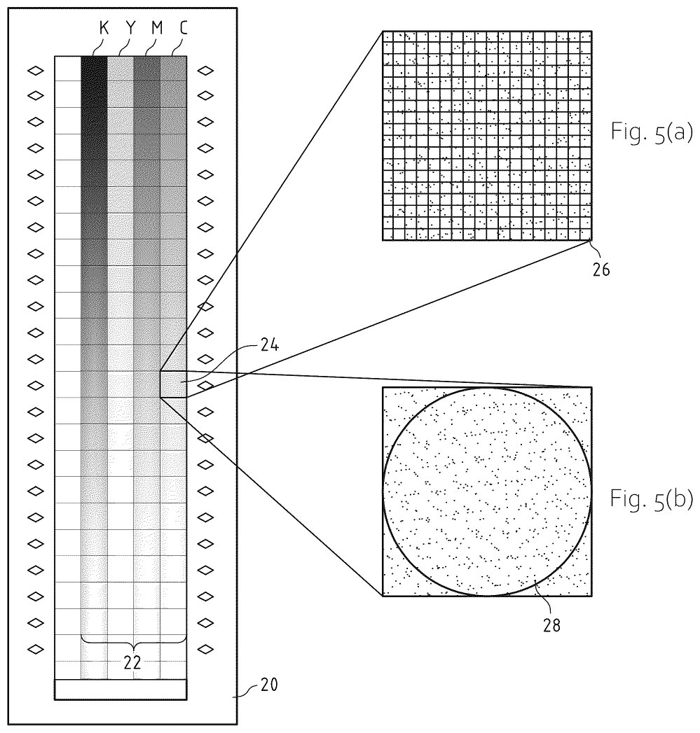

Firstly, a spectrally resolved reference reflectance is measured at a large number of measuring points for a still unprinted substrate 4 using the spatially resolved spectral measuring system 10. For this purpose, the colour printer is controlled in such a way that predetermined sections of the surface of the substrate 4 remain unprinted. This can be done in an inline process at the start of printing or at predetermined intervals during the printing process. As explained in FIG. 5, colour wedges regularly also have unprinted areas that can also be used to measure the reference reflectance. The measured spectral reference reflectances are stored for later recurring normalisation when determining the colour density D.

The colour printer 8 is then used to print a number of colour measuring patches, each with one print colour.

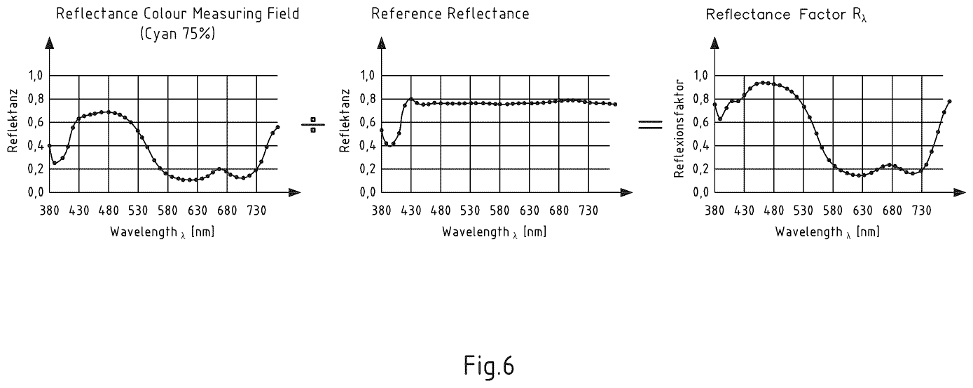

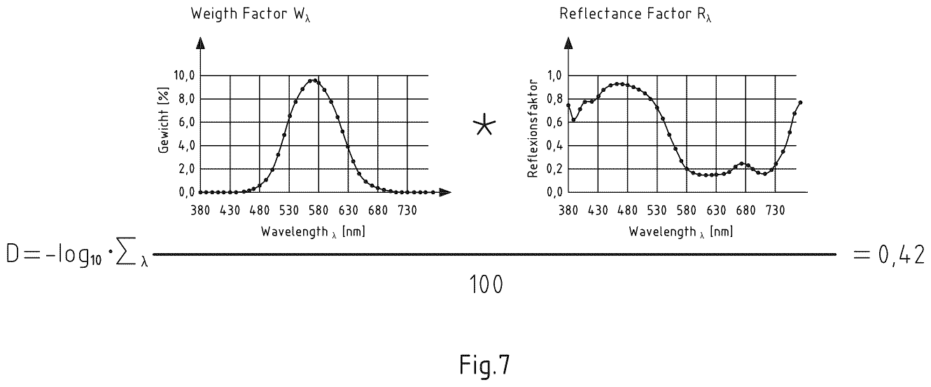

The spectral measurement system 10 is used to measure spectrally resolved reflectances for the colour measurement fields at a large number of measurement points and a colour density for the printing ink is calculated for each measurement point from the spectral distribution of the measured reflectance, the measured reference reflectance and a spectral weight function representing the printing ink. These process steps are explained in more detail in FIGS. 6 and 7.

FIG. 5 schematically shows a section of a substrate 20, which is formed by one of the previously described carrier materials 4. In the section shown, colour wedges for the four printing inks black (Key—K), yellow (Y), magenta (M) and cyan (C), marked in total with 22, have been printed as a sequence of colour measuring fields 24, the printing of which with the respective printing ink decreases in equal steps from top to bottom from 100% to 0% in the illustration according to FIG. 5. The colour measuring patches are then spectrally measured using the method described below and the colour density is determined from the measured values.

As FIGS. 5(a)-(b) show, the temporal print sequence runs from top to bottom, as does the subsequent measurement. During the measurement, the spectrally resolved reflectance for the colour measurement fields 24 is measured with the spatially resolved spectral measurement system 10 at a large number of measurement points 26 within each of the colour measurement fields 24, as shown in FIG. 5 (a) with a line grid.

Due to the large number of measuring points, it is possible to scan almost the entire area of the colour measuring field 24, so that a detailed evaluation of the reflectance measurement curves can be carried out.

FIGS. 6 and 7 show in a graphically prepared manner the application of the calculation of the colour density for a colour measurement field of the basic colour cyan according to the standard ISO 5.3 according to Appendix B and in particular according to Appendix B.4. Here it is specified for wavelength intervals of the wavelength bands of 10 nm or 20 nm how the calculation of the standard colour density is carried out according to equation B.2:

$$D = - log ( {\sum }_{λ} \frac{{W}_{λ} \times {R}_{λ}}{100} )$$

where W_{λ} is the spectral weighting factor of the wavelength λ, R_{λ} is the spectral reflectance factor of the wavelength λ and 100 is the sum of the spectral weighting factors over the wavelength range from 380 nm to 730 nm.

FIG. 6 first shows the calculation of the spectral distribution of the reflectance factor R_{λ} as a quotient of the spectral distribution of the reflectance of the colour measurement field and the spectral distribution of the reflectance of the unprinted substrate. The corresponding spectra are displayed instead of the mathematical expressions. For equal values of the wavelength λ, the corresponding values are then divided by each other. The result is a spectral distribution of the reflectance factor R_{λ} that is dependent on the wavelength λ.

FIG. 7 then shows in an equally clear way how the colour density D is calculated as the negative logarithm to the base 10 of the sum over all wavelengths λ via the products of the spectral distribution of the weighting factor W_{λ} for cyan and the spectral distribution of the reflectance factor R_{λ} for each value of λ divided by 100. In the example shown, this results in a value for the colour density D of 0.42.

As FIG. 5 (a) shows, the at least one colour measurement field is measured in a grid pattern at a large number of measurement points. A resolution of at least 30 dpi, preferably at least 70 dpi, in particular at least 90 dpi can be achieved.

In contrast, FIG. 5 (b) shows the situation as it is known from the prior art. The drawn circle 28 indicates the recorded area of a known colour densitometer, which uses its optical system to record the colour measurement field within the circle 28 with a spectral measurement curve. The colour measurement field was therefore not only recorded in less detail, but the area of the colour measurement field was also measured inadequately.

In contrast, according to the method shown in FIG. 5 (a), it is possible to measure the area of the colour measurement field essentially in its entirety, i.e. a large percentage of at least 80%, preferably at least 90%, in particular at least 95%.

The colour densities of all measurement points within a colour measurement field measured using the method described can be evaluated in various ways. For example, the colour densities can be averaged for at least two measuring points, preferably a plurality of measuring points and in particular for all measuring points of each colour measuring field. This means that average values can be calculated for individual groups of measuring points or even for all measuring points.

A particularly preferred evaluation of the measuring points is carried out in rows of measuring points that extend along the print direction, i.e. that have preferably been recorded inline and result in limited sections of the print head along the extension of the print direction. Thus, for example, a group of ink nozzles of a print head of the colour printer can be assigned to each measuring point 26 of the raster-shaped spectral colour density measurement of the at least one colour measuring field 24. Thus, information on the individual groups of colour nozzles can be derived from the spectral colour density measurements, which enables an assessment of the functionality of the groups of colour nozzles. For example, the group of ink nozzles can have a maximum of 10 ink nozzles, preferably a maximum of 5 ink nozzles, in particular one ink nozzle.

If, for example, rotogravure printing is used instead of a digital inkjet printer, the pattern to be printed in each of the printing colours is created as indentations in the roller surfaces. The indentations can be as small as 50 μm and are also referred to as a dotted roller. Systematic deviations in the print quality can occur when printing the colour measuring patches, which are included in the average spectral measurement value in an integral measurement of the entire colour measuring patch. During spectral measurement in the manner described above, average values can be calculated over all measurement points and measurement points with a systematic deviation from the average value that is too large can be disregarded when recalculating the average value of the spectral information. This improves the determination of the spectral information compared to an individual measurement according to the state of the art.

1. A method for spectral colour density measurement in colour printing,
in which a spectrally resolved reference reflectance is measured for an unprinted substrate using a spatially resolved spectral measurement system, preferably at a large number of measurement points,
in which at least one colour measuring field, preferably a plurality of colour measuring fields, is printed with at least one printing ink using a colour printer,
in which the spectrally resolved reflectance for at least one colour measurement field is measured with the spatially resolved spectral measurement system at a large number of measurement points, and
in which the colour density for the printing ink is calculated for each measuring point from the spectral distribution of the measured reflectance, the measured reference reflectance and a spectral weight function representing the printing ink.

2. The method according to claim 1,
in which the at least one colour measuring field is measured in a raster at a large number of measuring points with a resolution of at least 30 dpi, preferably at least 70, in particular at least 90 dpi.

3. The method according to claim 1,
in which at least 80%, preferably at least 90%, in particular at least 95% of the area of the at least one colour measurement field is measured.

4. The method according to claim 1,
in which the colour densities are averaged for at least two measuring points, preferably a plurality of measuring points and in particular for all measuring points of each colour measuring field.

5. The method according to claim 1,
in which a group of ink nozzles of a print head of the colour printer is assigned to each measuring point of the raster-shaped spectral colour density measurement of the at least one colour measuring field, and
in which the group of ink nozzles comprises at most 10 ink nozzles, preferably at most 5 ink nozzles, in particular one ink nozzle.
